(19) United States
(12) Patent Application Publication
(10) Pub. No.: US 2025/0334745 A1
(43) Pub. Date: Oct. 30, 2025

(54) PHOTOSYNTHETIC DEMULTIPLEXING CIRCUIT AND BRANCH RATIO ADJUSTMENT METHOD

(71) Applicant: NIPPON TELEGRAPH AND TELEPHONE CORPORATION, Tokyo (JP)

(72) Inventors: Takui UEMATSU, Musashino-shi, Tokyo (JP); Kazutaka NOTO, Musashino-shi, Tokyo (JP); Hiroyuki IIDA, Musashino-shi, Tokyo (JP); Hidenobu HIROTA, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/715,952

(22) PCT Filed: Dec. 6, 2021
(86) PCT No.: PCT/JP2021/044627

§ 371 Date: Nov. 25, 2024

(51) Int. Cl. G02B 6/293

(52) U.S. Cl. CPC G02B 6/2938

(57) ABSTRACT

To solve the problem, the present invention aims to provide an optical multiplexer/demultiplexer circuit that is detachable and can adjust a branching ratio, and a branching ratio adjustment method thereof.

The optical multiplexer/demultiplexer circuit 301 according to the present invention includes two blocks (10a, 10b) having a groove 12 on one surface 11 and configured such that polished surfaces (51a, 51b) of side-polished optical fiber core wires (50a, 50b) are fitted into the groove 12 to become a part of the surface 11, pressurizing units (20a, 20b) that pressurize the two blocks (10a, 10b) having the surfaces 11 in contact with each other with a magnetic force P in a direction (Z direction) in which the blocks come closer to each other, and an adjustment unit 30 that moves the two blocks (10a, 10b) being pressurized by the pressurizing units (20a, 20b) in a direction of a plane (X-Y plane) including the surfaces 11 to adjust a branching ratio.

### TECHNICAL FIELD

The present disclosure relates to an optical multiplexer/demultiplexer circuit and a branching ratio adjustment method thereof.

### BACKGROUND ART

A method for manufacturing an optical fiber coupler (optical multiplexer/demultiplexer circuit) using a side surface polishing method has been studied as one of optical multiplexing/demultiplexing techniques capable of demultiplexing light from a current optical fiber core wire or multiplexing light into a current optical fiber core wire without cutting the current optical fiber core wire (see, for example, Non Patent Literature 1).

A method of manufacturing the optical fiber coupler is as follows.

(Step 1) A current core wire is housed and fixed into a groove formed in a block having the groove designed for fitting a current core wire therein, the side surface of the current core wire is coated to a portion several μm apart from the core or to the core, and the cladding is polished.

(Step 2) The side surface of an optical waveguide for an optical multiplexing/demultiplexing buried in the block in advance is coated to a portion several μm apart from the core or to the core, and the cladding is polished.

(Step 3) The current core wire subjected to the side surface polishing and the polished surfaces of the optical waveguides for optical multiplexing/demultiplexing subjected to the side surface polishing in advance are brought into surface alignment, and the blocks are relatively moved in the polished surface direction to be fixed at a position where a desired branching ratio can be obtained.

### CITATION LIST

### Non Patent Literature

Non Patent Literature 1: Uematsu et al., “Sokumen kemmaho o mochiita Hikari bunki no kiso kento (in Japanese) (Study on optical fiber coupler using side-polishing method)”, IEICE Technical Report, vol. 119, no. 223, OFT2019-36, pp. 23-26, October 2019.

### SUMMARY OF INVENTION

### Technical Problem

In Non Patent Literature 1, in step (3), an ultraviolet curable resin is inserted between the polished surfaces, and after alignment, the blocks are irradiated with ultraviolet rays and fixed so that the blocks do not move relative to each other. However, the method of Non Patent Literature 1 has a problem that it is difficult to remove the optical multiplexer/demultiplexer circuit after the optical multiplexer/demultiplexer circuit becomes unnecessary since the blocks are fixed and the current core wire and the optical waveguide for optical multiplexing/demultiplexing cannot be separated. In addition, in the optical fiber coupler formed by using the method of Non Patent Literature 1, since the blocks are fixed to each other, there is also a problem that it is difficult to adjust the branching ratio.

Therefore, in order to solve the above problems, the present invention aims to provide an optical multiplexer/demultiplexer circuit that is detachable and can adjust a branching ratio, and a branching ratio adjustment method thereof.

### Solution to Problem

In order to achieve the above object, in an optical multiplexer/demultiplexer circuit according to the present invention, the blocks are not bonded and fixed to each other, but the blocks are pressurized and fixed by using a magnetic force in a direction in which the blocks come closer to each other.

Specifically, the optical multiplexer/demultiplexer circuit according to the present invention includes two blocks having a groove on one surface and configured such that a polished surface of a side-polished optical fiber core wire is fitted into the groove to become a part of the surface, a pressurizing unit that pressurizes the two blocks having surfaces in contact with each other with a magnetic force in a direction in which the blocks come closer to each other, and an adjustment unit that moves the two blocks being pressurized by the pressurizing unit in a direction of a plane including the surfaces to adjust a branching ratio.

In addition, a branching ratio adjustment method according to the present invention is a branching ratio adjustment method of an optical multiplexer/demultiplexer circuit including two blocks having a groove on one surface and configured such that a polished surface of a side-polished optical fiber core wire is fitted into the groove to become a part of the surface, the branching ratio adjustment method including continuously pressurizing the two blocks having the surfaces in contact with each other with a magnetic force in a direction in which the blocks come closer to each other, and moving the two blocks in a direction of a plane including the surfaces and adjusting a branching ratio.

In the method of the present invention, the blocks are not bonded and fixed to each other but pressurized in a direction in which the blocks are brought close to each other by the magnetic force, so that the branching ratio can be adjusted by relatively moving the blocks. In addition, after the optical multiplexing and demultiplexing become unnecessary, the relative movement amount between the blocks may be increased. By separating one optical fiber core wire from the other optical fiber core wire, coupling of light does not occur, and the optical multiplexer/demultiplexer circuit is removed. Furthermore, if the pressurization is stopped and the blocks are removed, the optical multiplexer/demultiplexer circuit can be completely removed.

The pressurizing units of the optical multiplexer/demultiplexer circuit according to the present invention are magnets arranged on opposite sides of the surfaces of the respective blocks so as to attract each other. Furthermore, the pressurizing unit of the optical multiplexer/demultiplexer circuit according to the present invention may be a magnet arranged on the opposite side of the surface of one of the blocks and a magnetic material arranged on the opposite side of the surface of the other block. The blocks can be easily and economically pressurized to be fixed and depressurized to be removed.

The optical multiplexer/demultiplexer circuit according to the present invention preferably further includes a compensation unit that compensates for a temperature variation of a pressure generated from the magnetic force. A branching ratio can be prevented from varying due to a temperature change.

Note that the inventions described above can be combined in any possible manner.

### Advantageous Effects of Invention

The present invention can provide an optical multiplexer/demultiplexer circuit that is detachable and can adjust a branching ratio, and a branching ratio adjustment method thereof.

### BRIEF DESCRIPTION OF DRAWINGS

FIG. 1 is a diagram for describing an optical multiplexer/demultiplexer circuit according to the present invention.

FIG. 2 is a diagram for describing a branching ratio adjustment method according to the present invention.

FIG. 3 is a diagram for describing an optical multiplexer/demultiplexer circuit according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference signs in the present specification and the drawings denote the same components.

### First Embodiment

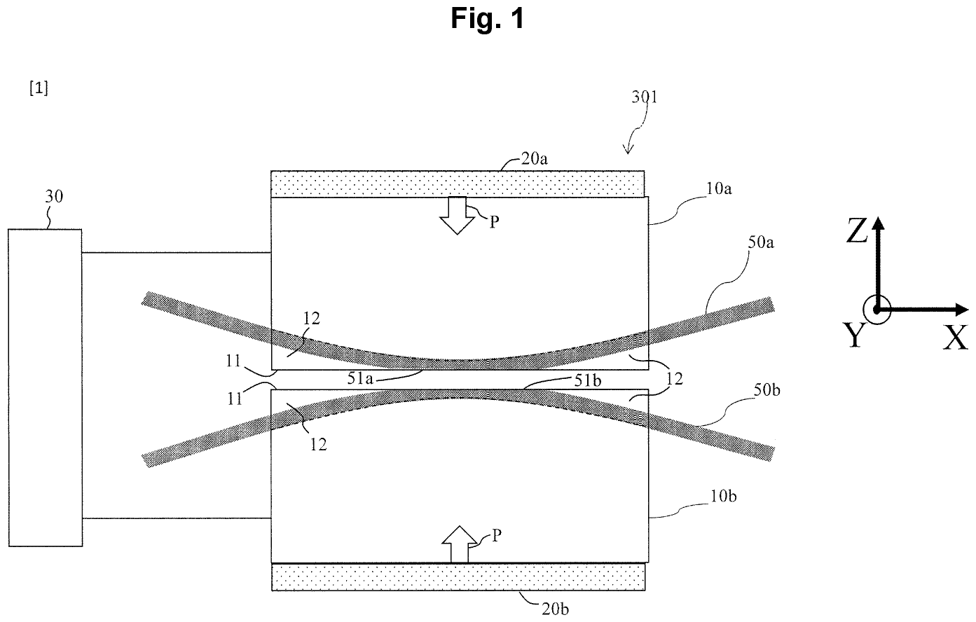

FIG. 1 is a diagram for explaining an optical multiplexer/demultiplexer circuit 301 according to the present embodiment. The optical multiplexer/demultiplexer circuit 301 includes:
two blocks (10a, 10b) having a groove 12 on one surface 11 and configured such that polished surfaces (51a, 51b) of side-polished optical fiber core wires (50a, 50b) are fitted into the groove 12 to become a part of the surface 11;
pressurizing units (20a, 20b) that pressurize the two blocks (10a, 10b) having the surfaces 11 in contact with each other at a pressure P in a direction (Z direction) in which the blocks come closer to each other; and
an adjustment unit 30 that moves the two blocks (10a, 10b) being pressurized by the pressurizing units (20a, 20b) in a direction of a plane (X-Y plane) including the surfaces 11 to adjust a branching ratio.

For example, the pressurizing units (20a, 20b) are magnets arranged on the opposite sides of the surface 11 of the respective blocks (10a, 10b) to attract each other. The magnets may be permanent magnets or electromagnets capable of adjusting a magnetic force P. In addition, any one of the pressurizing units (20a, 20b) may be a magnetic material. For example, the magnetic material is iron.

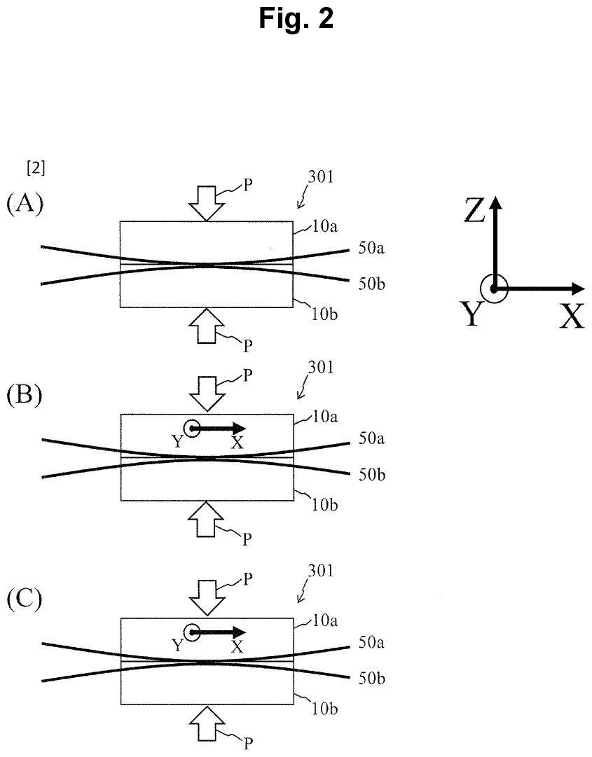

FIG. 2 is a diagram for describing a method for adjusting a branching ratio of the optical multiplexer/demultiplexer circuit 301. The method includes continuously pressurizing the two blocks (10a, 10b) with the surfaces 11 in contact with each other with a magnetic force P in a direction in which the blocks come close to each other (FIG. 2(A)), and moving the two blocks (10a, 10b) in the direction of the plane (X-Y plane) including the surfaces 11 to adjust the branching ratio (FIGS. 2(B) and 2(C)). Note that, in FIG. 2, the pressurizing units (20a, 20b) and the adjustment unit 30 are omitted.

The optical multiplexer/demultiplexer circuit 301 is characterized in that the pressurizing units (20a, 20b) continuously apply a constant force P to the blocks (10a, 10b) in a direction (Z direction) in which the blocks (10a, 10b) come each other to be constantly in contact with each other. FIG. 2(A) illustrates a state in which the pressurizing units (20a, 20b) bring the blocks (10a, 10b) into close contact with each other with a magnetic force P. Thus, the optical multiplexer/demultiplexer circuit 301 does not need to bond the blocks to each other with an ultraviolet curable resin or the like, and the optical multiplexer/demultiplexer circuit 301 can be removed afterwards.

FIG. 2(B) illustrates that the adjustment unit 30 moves the blocks (10a, 10b) in the direction of the X-Y plane with respect to each other while the blocks are pressurized with the magnetic force P to find a position where a desired branching ratio can be obtained. When the position where the desired branching ratio can be obtained is found, the adjustment unit 30 stops the relative movement of the blocks (10a, 10b). Since the pressurizing units (20a, 20b) continuously pressurize the blocks (10a, 10b) with the magnetic force P, the blocks are fixed at the position where a desired branching ratio can be obtained.

If the magnets are electromagnets, it is necessary to keep the current to be supplied constant so that the magnetic force P does not fluctuate before and after the relative movement of the blocks (10a, 10b) in order to avoid fluctuation of the branching ratio.

FIG. 2(C) illustrates removal of the optical multiplexer/demultiplexer circuit 301. When the optical multiplexer/demultiplexer circuit 301 is removed, the blocks (10a, 10b) are relatively moved on the X-Y plane, and the core interval is sufficiently separated (several tens μm or more). When the core interval is separated, optical multiplexing/demultiplexing is not performed. If the magnets are electromagnets, the pressurizing units (20a, 20b) may or may not apply the magnetic force P at the time of removal.

As described above, since the blocks are not bonded to each other, the optical multiplexer/demultiplexer circuit 301 can be removed when it becomes unnecessary after use. That is, the optical multiplexer/demultiplexer circuit 301 can simply and economically fix and remove the blocks.

### Second Embodiment

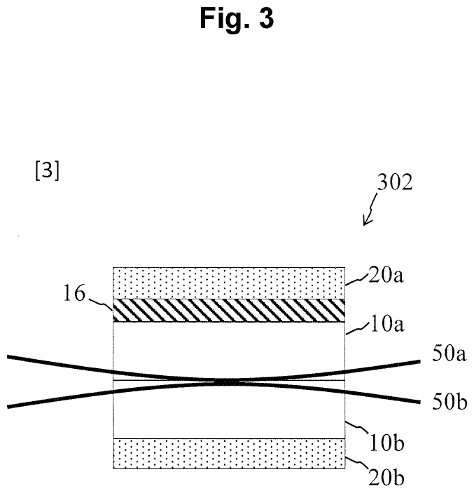

FIG. 3 is a diagram for describing an optical multiplexer/demultiplexer circuit 302 according to the present embodiment. The optical multiplexer/demultiplexer circuit 302 preferably further includes a compensation unit 16 that compensates in the optical multiplexer/demultiplexer circuit 301 of FIG. 1 for a temperature variation of a pressure of the magnetic force P.

The temperature dependence of the magnetic force P will be described.

Since the distance between the magnets becomes longer due to the temperature characteristics of the magnets and the expansion of the blocks (10a, 10b) as temperature increases, the magnetic force P decreases.

When the pressure P changes, a branching ratio of an optical multiplexer/demultiplexer changes. Therefore, a function of preventing the branching ratio from changing even when temperature changes is required.

Thus, in the optical multiplexer/demultiplexer circuit 302, the compensation unit 16 is installed between the block 10a and the pressurizing unit 20a so that the pressure for pressing the blocks (10a, 10b) becomes constant even when the temperature changes. For example, the compensation unit 16 is a spacer having a negative thermal expansion coefficient. The spacer having a negative thermal expansion coefficient is produced by mixing a material having a negative thermal expansion coefficient such as zirconium tungstate (ZrW₂O₈) or silicon oxide (Li₂O—Al₂O₃-nSiO₂) with a material having a normal positive thermal expansion coefficient.

Although an example of the magnets has been described together with the pressurizing units (20a, 20b) in the present embodiment, the same applies to a case where one of the pressurizing units is a magnetic material.

### REFERENCE SIGNS LIST

10a, 10b Block
11 Surface
12 Groove
16 Compensation unit
20a, 20b Pressurizing unit
30 Adjustment unit
50a, 50b Optical fiber core wire
51a, 51b Polished surface
301, 302 Optical multiplexer/demultiplexer circuit

1. An optical multiplexer/demultiplexer circuit comprising:
two blocks having a groove on one surface and configured such that a polished surface of a side-polished optical fiber core wire is fitted into the groove to become a part of the surface;
a pressurizing unit configured to pressurize the two blocks having surfaces in contact with each other with a magnetic force in a direction in which the blocks come closer to each other; and
an adjustment mechanism configured to move the two blocks in a direction of a plane including the surfaces in a state where the pressurizing unit pressurizes the blocks to adjust a branching ratio.

2. The optical multiplexer/demultiplexer circuit according to claim 1, wherein the pressurizing unit is a magnet disposed on an opposite side of the surface of each of the blocks to attract each other.

3. The optical multiplexer/demultiplexer circuit according to claim 1, wherein the pressurizing unit is a magnet arranged on an opposite side of a surface of one of the blocks and a magnetic material arranged on the opposite side of the surface of the other block.

4. The optical multiplexer/demultiplexer circuit according to claim 1, further comprising a compensation unit configured to compensate for a temperature variation of a pressure generated from the magnetic force.

5. A branching ratio adjustment method of an optical multiplexer/demultiplexer circuit including two blocks having a groove on one surface and configured such that a polished surface of a side-polished optical fiber core wire is fitted into the groove to become a part of the surface, the branching ratio adjustment method comprising:
continuously pressurizing the two blocks having surfaces in contact with each other with a magnetic force in a direction in which the blocks come closer to each other; and
moving the two blocks in a direction of a plane including the surfaces and adjusting a branching ratio.

6. The branching ratio adjustment method according to claim 5, wherein the magnetic force is generated by a magnet disposed on an opposite side of the surface of each of the blocks to attract each other.

7. The branching ratio adjustment method according to claim 5, wherein the magnetic force is generated by a magnet arranged on an opposite side of a surface of one of the blocks and a magnetic material arranged on the opposite side of the surface of the other block.

8. The branching ratio adjustment method according to claim 5, wherein a compensation unit compensates for a temperature variation of a pressure generated from the magnetic force.
